(19) United States
(12) Patent Application Publication
(10) Pub. No.: US 2006/0204412 A1
(43) Pub. Date: Sep. 14, 2006

(54) Water and steam management in fuel reformer

(76) Inventors: Vincent G. Rizzo, Norfolk, MA (US); Druva Dattatraya, Medford, MA (US); Brian J. Bowers, Cambridge, MA (US); Michael Ruffo, Medford, CA (US); Jian Lian Zhao, Belmont, MA (US)

Correspondence Address: FISH & RICHARDSON PC, P.O. BOX 1022, MINNEAPOLIS, MN, 55440-1022, US

(21) Appl. No.: 11/318,250

(22) Filed: Dec. 22, 2005

Related U.S. Application Data
(60) Provisional application No. 60/639,704, filed on Dec. 23, 2004.

(51) Int. Cl. B01J 19/00; C01B 3/26; G05B 1/00

(52) U.S. Cl. 422/198; 423/652; 422/105

(57) ABSTRACT

This invention relates to methods of water and steam management during fuel reforming, as well as related fuel reformers.

### CROSS REFERENCE TO RELATED APPLICATION

Under 35 U.S.C. §119, this application claims priority to U.S. Provisional Application Ser. No. 60/639,704, filed Dec. 23, 2004, the contents of which are incorporated herein by reference.

### TECHNICAL FIELD

The present invention is directed in general to the field of water and steam management during fuel reforming.

### BACKGROUND

Hydrogen can be made from a standard fuel, such as a liquid or gaseous hydrocarbon or alcohol, by a process including a series of reaction steps. In a first step, a fuel is typically heated together with other reactants (e.g., steam and/or air). The mixed gases then pass over a reforming catalyst to generate a mixture of hydrogen, carbon monoxide, carbon dioxide, and residual water via a reforming reaction. This process is referred to as “steam reforming” if the reactants include fuel and steam, “partial oxidation” if the reactants include fuel and air, or “autothermal reforming” (ATR) if the reactants include fuel, steam, and air. The product of this reaction is referred to as “reformate.” In a second step, the reformate is typically mixed with additional water. The water and carbon monoxide in the reformate react in the presence of a catalyst to form additional hydrogen and carbon dioxide via a water gas shift (WGS) reaction. The WGS reaction is typically carried out in two stages: a first high temperature shift (HTS) reaction stage and a second low temperature shift (LTS) reaction stage. The HTS and LTS reactions can maximize hydrogen production and reduce the carbon monoxide content in the reformate. If desired, further steps, such as a preferential oxidation (PrOx) reaction may be included to reduce the carbon monoxide content to a ppm level, e.g. 50 ppm or below. A reformate thus obtained contains a large amount of hydrogen and may be used as a fuel for a fuel cell. A device that includes reaction zones to perform the reaction steps described above is called a fuel reformer.

### SUMMARY

This invention relates to methods of water and steam management during fuel reforming, as well as related fuel reformers.

In one aspect of the invention, a method includes: (1) heating a water stream in a heat exchanger to obtain a mixture of steam and water; (2) separating the steam from the water in the mixture; (3) delivering the steam to a reforming reaction zone; and (4) adjusting a flow rate of the steam to maintain a predetermined steam-to-carbon ratio (e.g., from about 1.2 to about 4 or from about 1.5 to about 2.5) in the reforming reaction zone. The flow rate of the steam can be adjusted by a steam control device. The steam control device mentioned herein can include any device that regulates and controls steam flow, such as a steam flow meter or a steam valve.

In some embodiments, the method further includes delivering an air stream to a reaction zone selected from the group consisting of a burner, a high temperature shift reaction zone, a low temperature shift reaction zone, and a preferential oxidation reaction zone. The flow rate and/or a pressure of the steam delivered to the reforming reaction zone can be controlled by adjusting a flow rate of the air stream.

In some embodiments, the method can further include transferring thermal energy between the water stream in the heat exchanger and a heat source selected from the group consisting of a burner exhaust, a reformate exiting from the reforming reaction zone, a reformate exiting from a high temperature shift reaction zone, and a reformate in a preferential oxidation reaction zone. In certain embodiments, the method can further include adjusting a flow rate of the water stream in the heat exchanger to cool the reformate exiting from the reforming reaction zone to a temperature in the range of about 300° C. to about 450° C. In other embodiments, the method can further include adjusting a flow rate of the water stream in the heat exchanger to cool the refromate exiting from the high temperature shift reaction zone to a temperature in the range of about 200° C. to about 350° C. In still other embodiments, the method can further include adjusting a flow rate of the water stream in the heat exchanger to maintain the refromate in the preferential oxidation reaction zone at a temperature in the range of about 120° C. to about 250° C.

In another aspect of the invention, a fuel reformer includes a reforming reaction zone and a steam separator in fluid communication and upstream of the reforming reaction zone. The steam separator can be configured to separate steam from water and deliver the steam to the reforming reaction zone.

In some embodiments, the fuel reformer can further include a steam control device for adjusting a flow rate of the steam delivered from the steam separator to the reforming reaction zone to maintain a predetermined steam-to-carbon ratio in the reforming reaction zone. The steam control device can be disposed between the steam separator and the reforming reaction zone. In other embodiments, the steam separator can be configured to receive a mixture of water and steam from a heat exchanger selected from the group consisting of a heat exchanger disposed in a burner, a heat exchanger disposed between the reforming reaction zone and a high temperature shift reaction zone, a heat exchanger disposed between a high temperature shift reaction zone and a low temperature shift reaction zone, and a heat exchanger disposed in a preferential reaction zone.

In some embodiments, the fuel reformer can further include a heat exchanger that is configured to heat a water stream in the heat exchanger and inject the water stream exiting from the heat exchanger to a reformate generated from the reforming reaction zone. In other embodiments, the fuel reformer can further include a heat exchanger that is configured to heat an air stream in the heat exchanger and deliver the air stream to the reforming reaction zone.

In still another aspect of the invention, a method includes: (1) heating a water stream in a first heat exchanger, in which the water stream is completely vaporized to form a steam; (2) delivering the steam from the first heat exchanger to a reforming reaction zone; and (3) adjusting a flow rate of the water stream in the first heat exchanger to maintain a predetermined steam-to-carbon ratio (e.g., from about 1.2 to about 4 or from about 1.5 to about 2.5) in the reforming reaction zone. The flow rate of the water stream in the first heat exchanger can be adjusted by a water control device. The water control device mentioned herein can include any device that regulates and controls water flow, such as a mass flow controller, a metering valve, or a water injector.

In some embodiments, the method further includes delivering an air stream to a reaction zone selected from the group consisting of a burner, a high temperature shift reaction zone, a low temperature shift reaction zone, and a preferential oxidation reaction zone. The flow rate and/or a pressure of the steam delivered to the reforming reaction zone can be controlled by adjusting a flow rate of the air stream.

In some embodiments, the method can further include heating a water stream in a second heat exchanger to obtain a heated stream and delivering the heated stream to the first heat exchanger. The method can also include transferring thermal energy between the water in the second heat exchanger and a heat source mentioned above. In certain embodiments, the method can further include adjusting a flow rate of the water stream in the second heat exchanger to cool the reformate exiting from the reforming reaction zone to a temperature in the range of about 300° C. to about 450° C. or to cool the reformate exiting from the high temperature shift reaction zone to a temperature in the range of about 200° C. to about 350° C. In other embodiments, the method can further include adjusting a flow rate of the water stream in the second heat exchanger to maintain the reformate in the preferential oxidation reaction zone at a temperature in the range of about 120° C. to about 250° C.

In certain embodiments, the method can also include adding water to the first heat exchanger when a flow rate of the steam exiting from the first heat exchanger is smaller than a flow rate required to maintain the predetermined steam-to-carbon ratio in the reforming reaction zone.

In still another aspect of the invention, a fuel reformer includes a reforming reaction zone and a first heat exchanger in fluid communication and upstream of the reforming reaction zone. The first heat exchanger can be configured to completely vaporize a water stream in the first heat exchanger to obtain a steam and deliver the steam to the reforming reaction zone. In some embodiments, the first heat exchanger can be disposed in a burner.

In some embodiments, the reformer can further include a water control device for adjusting a flow rate of the water stream in the first heat exchanger to maintain a predetermined steam-to-carbon ratio in the reforming reaction zone. The water control device can be disposed upstream of the first heat exchanger.

In some embodiments, the first heat exchanger can be configured to receive a mixture of water and steam from a second heat exchanger selected from the group consisting of a heat exchanger disposed between the reforming reaction zone and a high temperature shift reaction zone, a heat exchanger disposed between a high temperature shift reaction zone and a low temperature shift reaction zone, and a heat exchanger disposed in a preferential reaction zone.

In some embodiments, the fuel reformer can further include a second heat exchanger that is configured to heat the water stream in the second heat exchanger and inject the water stream exiting from the second heat exchanger to a reformate generated from the reforming reaction zone. In other embodiments, the fuel reformer can further include a second heat exchanger that is configured to heat an air stream in the second heat exchanger and deliver the air stream to the reforming reaction zone.

In yet another aspect of the invention, the method includes: (1) heating a steam in a heat exchanger disposed in a burner; (2) delivering the steam from the heat exchanger to a reforming reaction zone; and (3) adjusting a flow rate of the steam in the first heat exchanger to maintain a predetermined steam-to-carbon ratio (e.g., from about 1.2 to about 4 or from about 1.5 to about 2.5) in the reforming reaction zone. In some embodiments, the steam can be heated by a burner exhaust.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a schematic illustration of an embodiment of an ATR fuel reformer having a steam separator.

FIG. 2 is graph showing a time response of a band-pass filter transfer function to a step change.

FIG. 3 is a schematic illustration of an embodiment of an ATR fuel reformer without a steam separator.

FIG. 4 is a schematic illustration of an embodiment of an ATR fuel reformer having a steam separator and a direct-water-injection heat exchanger.

FIG. 5 is a schematic illustration of an embodiment of an ATR fuel reformer having two direct-water-injection heat exchangers, but without a steam separator.

FIG. 6 is a schematic illustration of an embodiment of an ATR fuel reformer having a heat exchanger for pre-heating air supply to ATR zone.

Like reference symbols in the various drawings indicate like elements.

### DETAILED DESCRIPTION

In a ATR or SR-based fuel reformer, water is generally used as a reactant in a fuel reforming reaction and in a water gas shift reactions. Equations (A) and (B) illustrate typical reactions between water and other reactants in a fuel reforming reaction and a water gas shift reaction, respectively:
CₓH_{y}(g)+H₂O(g)→CO(g)+CO₂(g)+H₂(g) (A)
CO(g)+H₂O(g)⇄CO₂(g)+H₂(g) (B)

During a reforming process, water can prevent coke formation by carbon oxidization, provide a source for hydrogen, and prevent reactor overheat. It is therefore desirable to supply an adequate amount of water to various reaction zones in a fuel reformer during the reforming process. The amount of water required for certain reaction can be defined by the molar ratio between steam and carbon contained in the fuel, i.e., steam-to-carbon ratio. A typical steam-to-carbon ratio value for an autothermal reaction ranges from about 1.2 to about 4 (e.g., from about 1.5 to about 2.5).

Typically, water is preheated to form steam before being delivered into a fuel reforming reaction zone. Steam generation can be achieved through heat exchange between water and reaction streams in various high temperature process occurring during fuel reforming. Exemplary steam generation systems have been described in U.S. Pat. No. 6,641,625, the contents of which are herein incorporated by reference. Steam production rate can be determined by thermal inputs into various heat exchangers, which in turn can be determined by the fuel input to the fuel reformer.

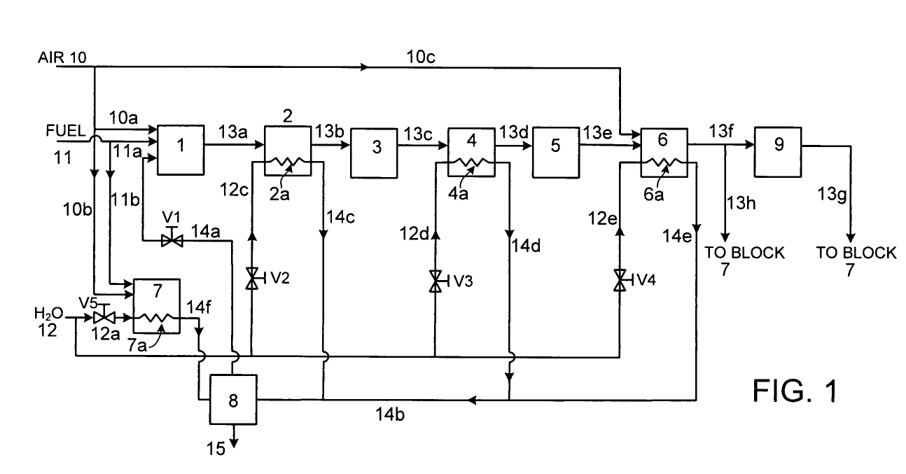

FIG. 1 is a schematic illustration of an embodiment of an ATR fuel reformer. The reformer includes, among others, an ATR reaction zone 1, a cooling zone 2, a HTS reaction zone 3, a cooling zone 4, a LTS reaction zone 5, a PrOx reaction zone 6, a burner 7, a steam separator 8, and a fuel cell stack 9. These components can be designed and manufactured by methods known in the art.

The fuel reformer also includes reactant inlets for feeding air 10, fuel 11, and water 12. During operation, air 10a, fuel 11a, and steam 14a are combined and fed into ATR reaction zone 1, which is embedded with an ATR catalyst. The reactants react in the presence of the ATR catalyst to form reformate 13a at a temperature in the range of about 700° C. to about 850° C. Hot reformate 13a then enters cooling zone 2. Cooling zone 2 contains a heat exchanger 2a, which uses water 12c for cooling reformate 13a. Cooling water 12c is either completely or partially vaporized in heat exchanger 2a and exits heat exchanger 2a as stream 14c (e.g., a steam or a steam-water mixture). Reformate 13a exits cooling zone 2 as reformate 13b, which typically has a temperature ranging from about 300° C. to about 450° C. (e.g., from about 300° C. to about 400° C.). Reformate 13b subsequently enters HTS reaction zone 3, in which a water gas shift reaction takes place. Since the water gas shift reaction generates heat, reformate 13c exiting HTS reaction zone 3 has a higher temperature than that of reformate 13b. Reformate 13c is then cooled by heat exchanger 4a in cooling zone 4 to a temperature suitable for the subsequent LTS reaction, which typically ranges from about 200° C. to about 350° C. (e.g., from 250° C. to about 350° C.). In cooling zone 4, cooling water 12d is either completely or partially vaporized in heat exchanger 4a and exits heat exchanger 4a as stream 14d (e.g., a steam or a steam-water mixture). Reformate 13d exiting from cooling zone 4 enters LTS reaction zone 5, in which another water gas shift reaction occurs at a temperature lower than the reaction in HTS reaction zone 3. Reformate 13e exiting LTS reaction zone 5 subsequently enters PrOx reaction zone 6, in which it is mixed with air 10c. The mixture reacts in the presence of a PrOx catalyst to further reduce carbon monoxide in the reformate. The heat generated from this process is transferred to the cooling water 12e inside a heat exchanger 6a, which resides in PrOx reaction zone 6. Cooling water 12e is either completely or partially vaporized in heat exchanger 6a and exits heat exchanger 6a as stream 14e (e.g., a steam or a steam-water mixture). The PrOx reaction temperature is typically controlled below about 250° C. (e.g., about 120° C. to 250° C.). Reformate 13e exits from the PrOx reaction zone 6 as reformate 13f. Reformate 13f can then be fed to fuel cell stack 9 if it has a carbon monoxide concentration sufficiently low for consumption by fuel cells (e.g. <100 ppm). Specifically, reformate 13f can pass through fuel cell anode in fuel cell stack 9 (not shown in FIG. 1) where the hydrogen in the reformate is partially consumed. The anode exhaust gas 13g can then be sent to burner 7 and combusted with air 10b. If reformate 13f has a carbon monoxide concentration higher than the required level, it is sent to burner 7 as reformate 13h and combusted. The combustion heat generated in burner 7 can be transferred to cooling water 12a in heat exchanger 7a to produce stream 14f (e.g., a steam or a steam-water mixture). In addition to combusting waste reformate, burner 7 can also combust fuel 11b if the heat generated from waste reformate combustion is not sufficient to generate the amount of steam required in ATR reaction zone 1.

The fuel reformer shown in FIG. 1 includes four components in which steam can be produced, i.e., heater exchanger 2a in cooling zone 2, heat exchanger 4a in cooling zone 4, heat exchanger 6a in PrOx zone 6, and heat exchanger 7a in burner 7. Cooling water 12c, 12d, 12e, and 12a in heat exchangers 2a, 4a, 6a, and 7a can be partially or completely vaporized to form streams 14c, 14d, 14e, and 14f (e.g., either steams or steam-water mixtures). Streams 14c, 14d, and 14e, can be combined to form stream 14b. Streams 14b and 14f can then be delivered to steam separator 8 and combined to form saturated steam 14a and water 15. In steam separator 8, water 15 is separated from steam 14a and drops out of the fuel reformer. Before sending to ATR reaction zone 1, steam 14a can be metered using a steam control device V1 based on the desired steam-to-carbon ratio in ATR reaction zone 1. The flow rates of cooling water 12c, 12d and 12e can be respectively adjusted by water control devices V2, V3, and V4 (e.g., valves) based on the desired temperatures of the reformate 13b, 13d, and 13f. The flow rate of cooling water 12e can also be adjusted based on the amount of air 10c delivered into PrOx reaction zone 6. The flow rate of cooling water 12a can be adjusted by a water control device V5 (e.g., a valve). The flow rate of water 15 dropping out of the fuel reformer is uncontrolled. The pressure of steam 14a (Psteam) defines the thermodynamic state of the steam since the volume of the steam is defined by the volume of heat exchangers and conduits connecting them, and saturated steam has a fixed temperature at a fixed pressure. Typically, Psteam should be maintained at a stable level for steam control device V1 to work properly. When Psteam is set at different values, different amount of steam 14a are metered by steam control V1 to maintain the same flow rate of steam 14a. Psteam can be controlled by adjusting the flow rate of air streams injected into different reaction zones (e.g., a burner, a HTS reaction zone, a LTS reaction zone, or a PrOx reaction zone)

Steam production rate can depend on the heat transfer rates in the heat exchangers, which can depend on different factors in different heat exchangers. For example, a heat transfer rate to heat exchanger 7a is determined by the flow rate of a fuel (e.g., a reformate or a hydrocarbon fuel) fed into burner 7. The heat available for transferring to the cooling water in heat exchangers 2a and 4a is determined by the sensible heat in the hot reformates in HTS reaction zone 3 and LTS reaction zone 5. In PrOx reaction zone 6, since a portion of hydrogen and carbon monoxide is combusted by air 10c during the PrOx reaction, the thermal energy released to heat exchanger 6a is determined by the flow rate of air 10c.

Fuel reformers can have configurations other than that described in FIG. 1. For example, one or more additional air injection points can be provided between the outlet of ATR reaction zone 1 and the outlet of LTS reaction zone 5. Consequently, combustion of reformate can occur at or near the air inlets, releasing thermal energy for use in steam generation. As another example, heat exchanger 2a or 4a coated with a catalyst (e.g., a combustion catalyst) can also be used to facilitate the combustion in HTS and LTS reactions. Such heat exchangers have been described in U.S. Utility application Ser. No. 11/201,002, the contents of which are herein incorporated by reference. As an additional example, multiple air injection points and heat exchangers can be provided at various stages in PrOx reaction zone 6.

The fuel reformer shown in FIG. 1 can be used in a compact fuel cell-fuel reformer system without an external water source, such as a system used to power a vehicle. In such a system, the fuel reforming reaction is preferred to be operated at a low steam-to-carbon ratio (e.g., from 1.5 to 2.5). Specifically, water is consumed in the fuel reformer (see Equations A and B) and regenerated in the fuel cell by oxidation of hydrogen. The regenerated water can then be condensed, collected, and fed back to the fuel reforming reaction. The amount of condensed water typically depends on the cooling medium and the size of the condenser. The larger the condenser and the colder the cooling medium, the larger amount of water can be condensed and collected. In a compact fuel cell-fuel reformer system, the condenser volume is typically small and the cooling medium is typically air at ambient temperature. Since there is no external water source, it is advantageous to operate the fuel reforming reaction at a low steam-to-carbon ratio to accommodate the size of a compact fuel cell-fuel reformer system.

Typically, to achieve stable system performance, a fixed steam-to-carbon ratio is maintained during steady states as well as during transient states in the full range of power input. The steam flow rate can be controlled by steam control device V1, which typically only has a tolerance of small pressure fluctuations (e.g., within 10 psig or within 5 psig). It is therefore preferable to maintain a stable steam pressure for measuring and supplying the right amount of steam based on the predetermined steam-to-carbon ratio in ATR reaction zone 1.

To control steam pressure of a fuel reformer, a non-linear dynamic model can be developed and implemented by a simulation program MATLAB/SIMULINK (available from The Mathworks, Inc., Natick Mass.). The model can consist of a series of non-linear equations using material and energy streams as inputs to predict temperatures and steam generation in the fuel reformer. The model can be linearized using Taylor expansion and the resultant linear equations can be represented in a state space equation as shown in Equation 1.

$$\frac{ⅆ x}{ⅆ t} = A * x + B * u \\ Y = C * x + D * u \qquad Equation 1$$

The inputs, “u,” can include inlet temperatures, as well as mass flow rates of steams and reactant streams. The outputs, “Y,” can include exit temperatures and exit steam mass flow rates. A and B represent matrices that are obtained from linear equations governing the heat exchangers. C and D represent output matrices that are obtained from the same group of linear equations.

The state space equation 1 can be translated into a group of transfer functions. Experiments can be conducted to obtain values for the parameters in these transfer functions. This procedure is called system identification. Equations 2 and 3 show how system steam pressure corresponds to the fuel mass flow rate to a burner and the air flow rate to a PrOx zone, respectively. PID controller using burner fuel flow and PrOx air flow can be designed based on these two equations. Frequency-response analysis can be performed to determine the bandwidth of these controllers. In general, the larger the bandwidth, the faster the system responds.

$$\begin{matrix}\frac{Steam Pressure}{burnerFuelFlow} = \frac{238.26 ( s + 1.15 ) ( s + 0.2536 ) ( s + 0.102 ) ( s + 0.04915 )}{( s + 3.786 ) ( s + 0.314 ) ( s + 0.1172 ) ( s + 0.03835 ) ( s + 0.0035 )} & Equation 2 \\ \frac{Steam Pressure}{PrOxAirFlow} = \frac{0.94822 ( s + 0.3732 ) ( s + 0.2088 ) ( s + 0.1034 )}{( s + 3.786 ) ( s + 0.314 ) ( s + 0.1172 ) ( s + 0.03835 ) ( s + 0.03835 )} & Equation 3\end{matrix}$$

A model using both burner fuel flow rate and PrOx air flow rate as control inputs can be established based on Linear Quadratic Regulator (LQR). LQR is frequently used to treat multivariable control problems. See “Control System Design” by Goodwin, Graebe, and Salgado, Printice Hall 2000, the contents of which are herein incorporated by reference. A frequency analysis of the above-mentioned model can be conducted to determine is bandwidth. Typically, the bandwidth of a model using two control inputs surpasses that of the models using only one control input. The LQR-based control model mentioned above can adjust both burner fuel flow and PrOx air flow to achieve a stable steam pressure. In some embodiments, it is preferable to minimize changes in one of the two flow rates while relying more on the other as the primary control input. For instance, since combustion in the PrOx reactor may cause overheating of the PrOx reactor or the PrOx catalyst, it is desirable to limit the magnitude and the duration of PrOx air flow to the steam pressure deviation. To do so, a band-pass filter transfer function such as the one expressed in Equation 4 below can be used.

$$\frac{PrOxAirOut}{PrOxAirInput} = \frac{5.0505 s}{( s + 0.005 ) ( s + 5 )} \qquad Equation 4$$

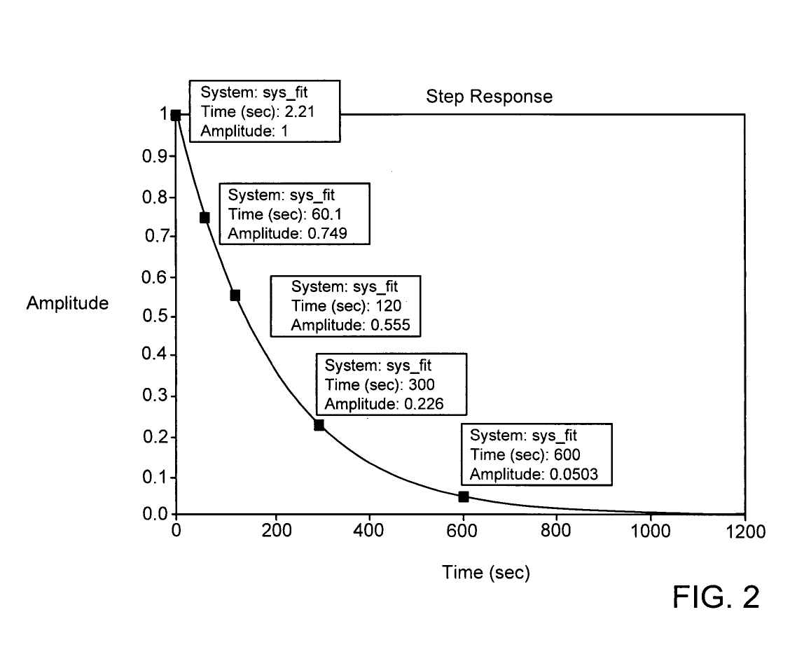

FIG. 2 illustrates a time response of the band-pass filter transfer function shown in Equation 4 to a step change. It shows that this function allows a unity gain at 2.2 second after the step change and then gradually depresses the gain. FIG. 2 indicates that the PrOx air responds immediately to a step change in the steam pressure with full gain but is less sensitive to the changes in the steam pressure afterwards. It is noted that such a band-pass filter can be applied to either PrOx air or burner fuel, depending on which one provides a more stable operation.

Typically, steam pressure is determined by the pressure drop encountered in delivering the steam. Operation at a high thermal input requires a high steam flow rate to maintain a proper steam-to-carbon ratio in ATR reaction zone and therefore results in a high pressure drop. Operation at a low thermal input requires a lower steam flow rate which results in a lower pressure drop in the same fuel reforming system. The minimum steam pressure at each power input can be experimentally determined. Operation at the minimum steam pressure can achieve better energy efficiency during steady states. However, at system transient states, a steam buffer can be desirable since it can provide extra steam to meet the high steam demand when power input increases or accommodate extra steam when power input decreases. The steam buffer can be formed by applying a weighting function to the minimum steam pressure corresponding to each power input. For example, the weighting function can set a steam pressure higher than the minimum steam pressure, thereby forming a steam buffer for providing extra steam when the system has a relative low power input. The weighting function can vary according to system characteristics and operational demands.

It is to be noted that burner air flow rate corresponds to burner fuel flow rate at the operating temperature and therefore can be used to replace burner fuel flow rate as a control input. Further, if additional air streams are injected into different reaction zones (e.g., a HTS reaction zone, a LTS reaction zone, or a PrOx reaction zone), the flow rates of these air streams can serve as additional control inputs for steam pressure.

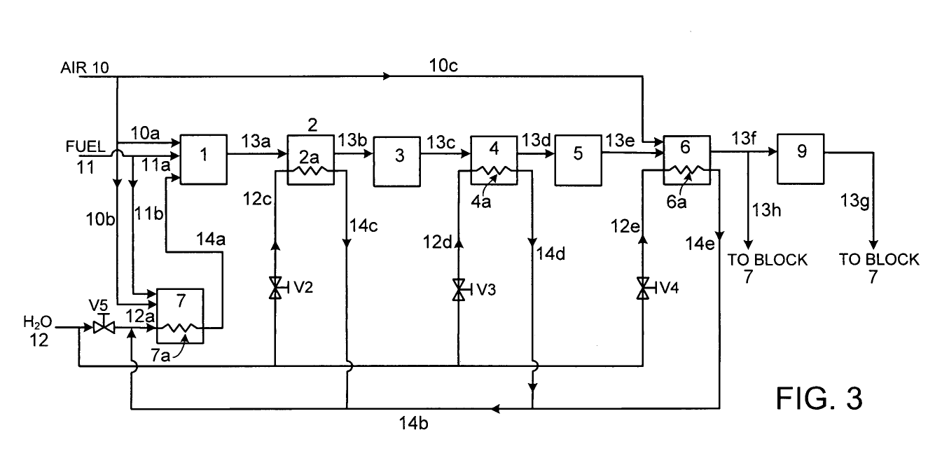

In some embodiments, the amount of steam fed to the fuel reformer can be adjusted by controlling the amount of water introduced to the fuel reformer, without using any steam control device. FIG. 3 illustrates such an embodiment. Identical reference symbols in FIGS. 1 and 3 designate the identical components or streams. The fuel reformer shown in FIG. 3 does not have steam separator 8 shown in FIG. 1. The steam required for the reaction in ATR reaction zone 1 is supplied from heat exchanger 7a. During operation, cooling water streams 12c, 12d, and 12e are delivered to heat exchangers 2a, 4a, and 6a, respectively. The flow rates of cooling water streams 12c, 12d, and 12e can respectively be determined by the amount of water required to cool reformates 13b, 13d, and 13f to their predetermined temperatures and adjusted by water control devices V2, V3, and V4. Cooling water streams 12c, 12d, and 12e can be completely or partially vaporized in heat exchangers 2a, 4a, and 6a to form streams 14c, 14d, and 14e (e.g., either steams or steam-water mixtures), which can be combined to obtain stream 14b. Stream 14b can be optionally combined with water 12 to form stream 12a, which can then be delivered to heat exchanger 7a. Stream 12a is fully vaporized in heat exchanger 7a to form steam 14a, which is subsequently delivered to ATR reaction zone 1.

The desired flow rate of steam 14a or stream 12a can be adjusted by water control device V5 based on the predetermined steam-to-carbon ratio (e.g. from about 1.5 to about 2.5) in ATR reaction zone 1. For example, if the desired flow rate of steam 14a is larger than the flow rate of stream 14b, water can be added through water control device V5 to make up the difference. If the desired flow rate of steam 14a is smaller than the flow rate of stream 14b, water control device V5 is kept closed so that the flow rate of steam 14a equals that of stream 14b. In the latter case, more steam is fed to the ATR reaction zone 1 than the predetermined value.

When cooling water streams 12c, 12d, and 12e are completely vaporized in heat exchangers 2a, 4a, and 6a, streams 14c, 14d, and 14e contain steam only. The steam in streams 14c, 14d, and 14e can then be combined to form stream 14b, which can be sent to heat exchanger 7a as stream 12a. The steam in stream 12a can be heated in heat exchanger 7a to a predetermined temperature and then sent to ATR reaction zone 1 as steam 14a. If the flow rate of steam 14a is high enough to maintain the predetermined steam-to-carbon ratio in ATR zone 1, water 12 is not required to be added to stream 12a. In this case, the flow rate of steam 14a or stream 12a, which contains steam only, is controlled by water control devices V2, V3, and V4.

The fuel reformer shown in FIG. 3 can provide the following advantages: Since stream 12a is completely vaporized in heat exchanger 7a, the fuel reformer does not require a steam separator to separate water from steam. In other words, it has a simpler configuration than the fuel reformer shown in FIG. 1. Further, the amount of steam in ATR reaction zone 1 can be regulated by water control devices V2, V3, V4, and V5. No steam control device is required in the fuel reformer shown in FIG. 3. Since controlling water flow rate is generally easier than controlling steam flow rate, the operation of the fuel reformer shown in FIG. 3 is also simpler than that of the fuel reformer shown in FIG. 1.

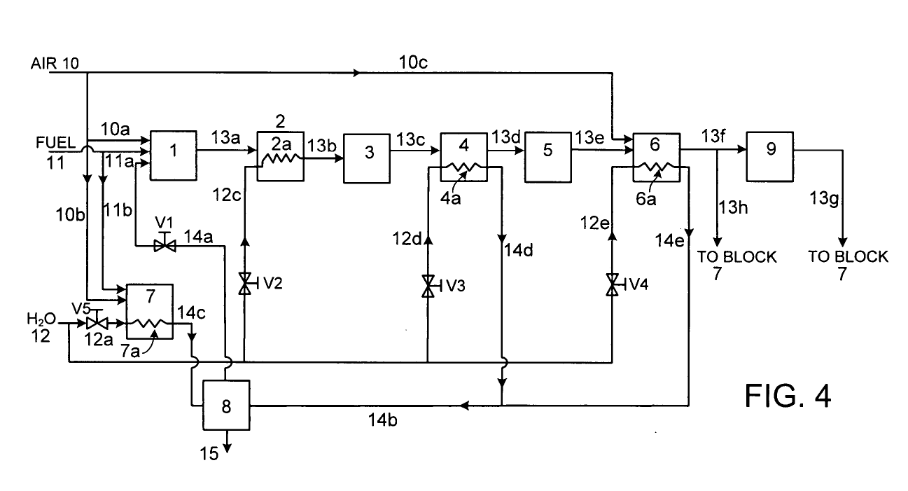

During the operation of the fuel reformers of FIGS. 1 and 3, the steam-to-carbon ratios at all locations inside the fuel reformer are identical. The steam-to-carbon ratio, however, can be altered by injecting water into different reaction zones. FIG. 4 illustrates such an embodiment. The fuel reformer shown in FIG. 4 is similar to that shown in FIG. 1 except that the steam-to-carbon ratio in HTS reaction zone 3 can be altered. Specifically, during the operation of the fuel reformer shown in FIG. 4, cooling water stream 12c, after being heated in heat exchanger 2a, is not delivered to steam separator 8 as stream 14c. It is instead injected into the hot reformate in HTS zone 3 through an outlet of heat exchanger 2a. Such a heat exchanger 2a has been described in U.S. application Ser. No. 11/156,919, the contents of which are incorporated herein by reference. Similar operation can be done to cooling water streams 12d and 12e.

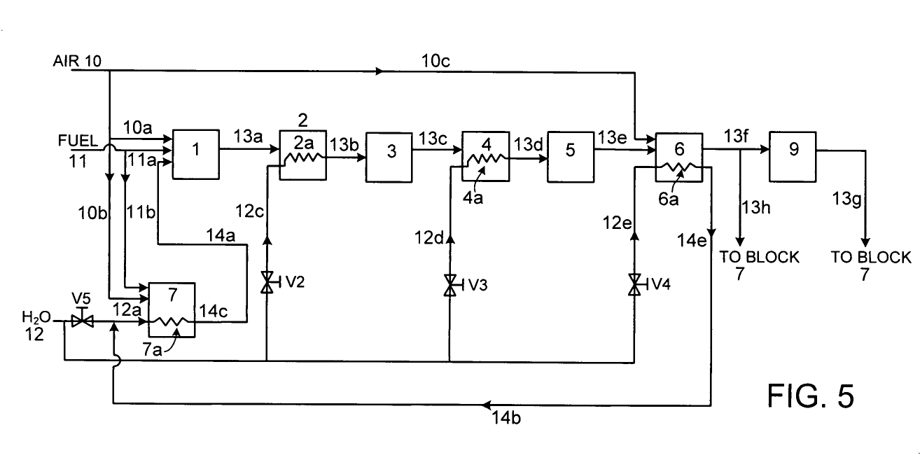

FIG. 5 illustrates a fuel reformer similar to that shown in FIG. 3 except that the steam-to-carbon ratios in both HTS reaction zone 3 and LTS reaction zone 5 can be altered. Specifically, during operation, cooling water streams 12c and 12d are respectively injected into the reformates in HTS reaction zone 3 and LTS reaction zone 5 after being heated in heat exchangers 2a and 4a. They are not used for generating stream 14b. Stream 14b is formed from stream 14e only and is combined with water 12 to form 12a, which is completely vaporized in heat exchanger 7a to form steam 14a. Steam 14a can then be fed to ATR reaction zone 1. In this embodiment, the steam-to-carbon ratios of reformates 13a, 13b, and 13d differ from each other. Since there is no water dropping out of the fuel reformer, the steam-to-carbon ratio in any location in the fuel reformer can be easily calculated and readily controlled by adjusting local water flow rates.

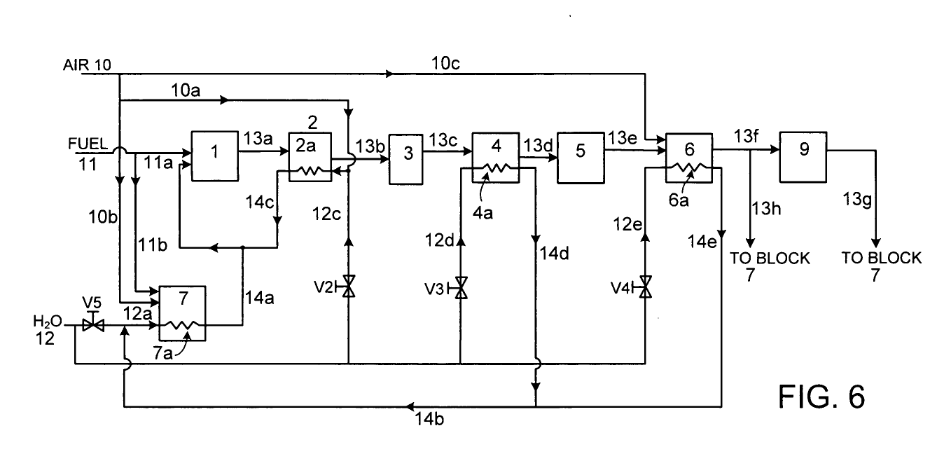

FIG. 6 illustrates a fuel reformer similar to that shown in FIG. 3 except that it is configured to combine air 10a with cooling water 12c before they enter heat exchanger 2a. During operation, air 10a is heated and cooling water 12c is completely vaporized in heat exchanger 2a. They then exit heat exchanger 2a as stream 14c. Stream 14c combines with steam 14a before entering ATR reaction zone 1. In the fuel reformer shown in FIG. 6, heat exchanger 2a is used as both a pre-heater for air 10a and a steam generator that produce steam from cooling water 12c.

A number of embodiments of the invention have been described. Nevertheless, it will be understood that various modifications may be made without departing from the spirit and scope of the invention. Accordingly, other embodiments are within the scope of the following claims.

What is claimed is:

1. A method, comprising:
heating a water stream in a heat exchanger to obtain a mixture of steam and water;
separating the steam from the water in the mixture;
delivering the steam to a reforming reaction zone; and
adjusting a flow rate of the steam to maintain a predetermined steam-to-carbon ratio in the reforming reaction zone.

2. The method of claim 1, wherein the steam-to-carbon ratio ranges from about 1.2 to about 4.

3. The method of claim 1, wherein the steam-to-carbon ratio ranges from about 1.5 to about 2.5.

4. The method of claim 1, wherein the flow rate of the steam is adjusted by a steam control device.

5. The method of claim 1, further comprising delivering an air stream to a reaction zone selected from the group consisting of a burner, a high temperature shift reaction zone, a low temperature shift reaction zone, and a preferential oxidation reaction zone, the flow rate of the steam delivered to the reforming reaction zone being controlled by adjusting a flow rate of the air stream.

6. The method of claim 1, further comprising delivering an air stream to a reaction zone selected from the group consisting of a burner, a high temperature shift reaction zone, a low temperature shift reaction zone, and a preferential oxidation reaction zone, a pressure of the steam delivered to the reforming reaction zone being controlled by adjusting a flow rate of the air stream.

7. The method of claim 1, further comprising transferring thermal energy between the water stream in the heat exchanger and a heat source selected from the group consisting of a burner exhaust, a reformate exiting from the reforming reaction zone, a reformate exiting from a high temperature shift reaction zone, and a reformate in a preferential oxidation reaction zone.

8. The method of claim 7, further comprising adjusting a flow rate of the water stream in the heat exchanger to cool the reformate exiting from the reforming reaction zone to a temperature in the range of about 300° C. to about 450° C.

9. The method of claim 7, further comprising adjusting a flow rate of the water stream in the heat exchanger to cool the reformate exiting from the high temperature shift reaction zone to a temperature in the range of about 200° C. to about 350° C.

10. The method of claim 7, further comprising adjusting a flow rate of the water stream in the heat exchanger to maintain the reformate in the preferential oxidation reaction zone at a temperature in the range of about 120° C. to about 250° C.

11. A fuel reformer, comprising:
a reforming reaction zone; and
a steam separator in fluid communication and upstream of the reforming reaction zone, wherein the steam separator is configured to separate steam from water and deliver the steam to the reforming reaction zone.

12. The reformer of claim 11, further comprising a steam control device for adjusting a flow rate of the steam delivered from the steam separator to the reforming reaction zone to maintain a predetermined steam-to-carbon ratio in the reforming reaction zone.

13. The reformer of claim 12, wherein the steam control device is disposed between the steam separator and the reforming reaction zone.

14. The reformer of claim 11, wherein the steam separator is configured to receive a mixture of water and steam from a heat exchanger selected from the group consisting of a heat exchanger disposed in a burner, a heat exchanger disposed between the reforming reaction zone and a high temperature shift reaction zone, a heat exchanger disposed between a high temperature shift reaction zone and a low temperature shift reaction zone, and a heat exchanger disposed in a preferential reaction zone.

15. The reformer of claim 11, further comprising a heat exchanger that is configured to heat a water stream in the heat exchanger and inject the water stream exiting from the heat exchanger to a reformate generated from the reforming reaction zone.

16. The reformer of claim 11, further comprising a heat exchanger that is configured to heat an air stream in the heat exchanger and deliver the air stream to the reforming reaction zone.

17. A method, comprising:
heating a water stream in a first heat exchanger, the water stream being completely vaporized to form a steam;
delivering the steam from the first heat exchanger to a reforming reaction zone; and
adjusting a flow rate of the water stream in the first heat exchanger to maintain a predetermined steam-to-carbon ratio in the reforming reaction zone.

18. The method of claim 17, wherein the steam-to-carbon ratio ranges from about 1.2 to about 4.

19. The method of claim 17, wherein the steam-to-carbon ratio ranges from about 1.5 to about 2.5.

20. The method of claim 17, further comprising:
heating a water stream in a second heat exchanger to obtain a heated stream; and
delivering the heated stream to the first heat exchanger.

21. The method of claim 20, further comprising transferring thermal energy between the water stream in the second heat exchanger and a heat source selected from the group consisting of a reformate exiting from the reforming reaction zone, a reformate exiting from a high temperature shift reaction zone, and a reformate in a preferential oxidation reaction zone.

22. The method of claim 21, further comprising adjusting a flow rate of the water stream in the second heat exchanger to cool the reformate exiting from the reforming reaction zone to a temperature in the range of about 300° C. to about 450° C.

23. The method of claim 21, further comprising adjusting a flow rate of the water stream in the second heat exchanger to cool the reformats exiting from the high temperature shift reaction zone to a temperature in the range of about 200° C. to about 350° C.

24. The method of claim 21, further comprising adjusting a flow rate of the water stream in the second heat exchanger to maintain the reformate in the preferential oxidation reaction zone at a temperature in the range of about 120° C. to about 250° C.

25. The method of claim 17, wherein the flow rate of the water stream in the first heat exchanger is adjusted by a water control device.

26. The method of claim 17, further comprising delivering an air stream to a reaction zone selected from the group consisting of a burner, a high temperature shift reaction zone, a low temperature shift reaction zone, and a preferential oxidation reaction zone, the flow rate of the steam delivered to the reforming reaction zone being controlled by adjusting a flow rate of the air stream.

27. The method of claim 17, further comprising delivering an air stream to a reaction zone selected from the group consisting of a burner, a high temperature shift reaction zone, a low temperature shift reaction zone, and a preferential oxidation reaction zone, a pressure of the steam delivered to the reforming reaction zone being controlled by adjusting a flow rate of the air stream.

28. The method of claim 17, further comprising adding water to the first heat exchanger when a flow rate of the steam exiting from the first heat exchanger is smaller than a flow rate required to maintain the predetermined steam-to-carbon ratio in the reforming reaction zone.

29. A fuel reformer, comprising:
a reforming reaction zone; and
a first heat exchanger in fluid communication and upstream of the reforming reaction zone, wherein the first heat exchanger is configured to completely vaporize water stream in the first heat exchanger to obtain a steam and deliver the steam to the reforming reaction zone.

30. The reformer of claim 29, wherein the first heat exchanger is disposed in a burner.

31. The reformer of claim 29, further comprising a water control device for adjusting a flow rate of the water stream in the first heat exchanger to maintain a predetermined steam-to-carbon ratio in the reforming reaction zone.

32. The reformer of claim 31, wherein the water control device is disposed upstream of the first heat exchanger.

33. The reformer of claim 29, wherein the first heat exchanger is configured to receive a mixture of water and steam from a second heat exchanger selected from the group consisting of a heat exchanger disposed between the reforming reaction zone and a high temperature shift reaction zone, a heat exchanger disposed between a high temperature shift reaction zone and a low temperature shift reaction zone, and a heat exchanger disposed in a preferential reaction zone.

34. The reformer of claim 29, further comprising a second heat exchanger that is configured to heat the water stream in the second heat exchanger and inject the water stream exiting from the second heat exchanger to a reformate generated from the reforming reaction zone.

35. The reformer of claim 29, further comprising a second heat exchanger that is configured to heat an air stream in the second heat exchanger and deliver the air stream to the reforming reaction zone.

36. A method, comprising:
heating a steam in a heat exchanger disposed in a burner;
delivering the steam from the heat exchanger to a reforming reaction zone; and
adjusting a flow rate of the steam in the first heat exchanger to maintain a predetermined steam-to-carbon ratio in the reforming reaction zone.

37. The method of claim 36, wherein the steam-to-carbon ratio ranges from about 1.2 to about 4.

38. The method of claim 36, wherein the steam-to-carbon ratio ranges from about 1.5 to about 2.5.

39. The method of claim 36, wherein the steam is heated by a burner exhaust.
